(19) United States
(12) Patent Application Publication
(10) Pub. No.: US 2004/0074405 A1
(43) Pub. Date: Apr. 22, 2004

(54) Stand for supporting a frame

(76) Inventor: Andrew L. Oleson, Carol Stream, IL (US)

Correspondence Address: Wallenstein & Wagner, Ltd., 53rd Floor, 311 S. Wacker Drive, Chicago, IL, 60606-6630, US

(21) Appl. No.: 10/272,454

(22) Filed: Oct. 16, 2002

(51) Int. Cl. B41L 13/00; B05C 17/06

(52) U.S. Cl. 101/127.1

(57) ABSTRACT

The present invention is to a stand (10) for supporting framed (100) screens (200) during the coating, developing and cleaning processes. The stand (100) includes one or more braces (40) supporting a top portion (30) substantially parallel to a bottom portion (20). The top portion (30) rotates relative to the bottom portion (20) to permit one to remove or insert a frame into the stand (10). The top and bottom portions (20,30) support shafts (52) that are selectively rotated by a controller assembly (60) and an actuator assembly (80). As a result, one can clean, coat or treat the front of the screen and then the back of the screen without touching, lifting or physically moving the screen. This facilitates the coating, exposing, developing and cleaning processes associated with screens used in screen printing.

### DESCRIPTION

1. Technical Field

The present invention relates to screen printing, and more particularly, to a stand for supporting such a screen during the coating, developing and cleaning processes. The stand permits one to act upon (such as cleaning) the front of the screen and then act upon (such as cleaning) the back of the screen without touching, lifting or physically moving the screen being acted upon. In short, one can stand in a single location, spray and clean one face of the screen, effectuate rotation of the screen, spray and clean the other face of the screen, and continue repeating this process, all while having the screen securely supported. In addition, the stand facilitates coating the screen prior to exposure and processing the screen after exposure.

2. Background of the Invention

Printed indicia for applying to items of clothing, such as T-shirts, sweatshirts, golf shirts, shorts, hats, and the like, as well as other cloth and paper goods, such as banners, posters, bags, flags, and the like, have become very popular over the last 25 years. Boutiques specializing in printing fanciful and textual indicia such as slogans, college names, sports team names and logos, licensed characters, and the like, on these various media, are commonly seen in stores across the country. The indicia available at these stores can be pre-printed on a substrate and applied with a heated press by operators at such boutiques to any of the aforementioned items purchased by a consumer, or they can be screen printed directly onto the items for later purchase.

In the screen printing process, a stencil screen is typically blocked (called “masked” in the industry) to embody the desired indicia and then placed over the item to be printed. Ink of one color is then added to the screen surface and flooded onto the indicia by a flood bar of conventional design. The ink may be of any type well-known in the industry for screen printing. After the ink is flooded onto the screen, the ink is squeegeed through the screen interstices onto the item, leaving ink of the desired color where the interstices in the screen are unblocked. The squeegee can be of any type known in the art. Each color is applied separately through screen printing. At times during the printing process the article is also cured or dried through conventional and well known means to set the ink and prevent smearing etc. After printing is completed on the item, the item printed upon is typically moved to a dryer or the like to permanently set the ink onto the substrate or textile.

Assignee of the present invention, M&R Printing Equipment, Inc., Glen Ellyn, Ill., makes several successful printing presses, such as the PROCESSOR®, the RENEGADE™, the PATRIOT®, the ECLIPSE™, the SATURN™, the ADVANTAGE™, the CONQUEST™, the CHALLENGER®, the GAUNTLET®, the SPORTSMAN™, the TERMINATOR™, the ULTIMATE®, the PREDATOR®, the CHAMELEON®, the PREMIERE™, and the PERFORMER™ screen printing systems.

As to particulars, a screen printing machine has at least one station for each color employed. For example, a design incorporating two colors will have at least two printing stations, one for each color. A design employing eight colors will have at least eight stations. Each station generally includes a printing head, which supports a single screen, the ink to be used at that station and a mechanism for applying the ink to the textile. Each color is carried by a single screen. The substrate to be screened travels from printing station to printing station by one of a number of methods, such as a chain or a rigid arm.

Immediately following is a brief summary of the process leading up to the actual printing, just described.

First, the artwork is set up. The artwork, in the form of a film positive, is secured on a layout board. Next, a carrier sheet (optically clear polyester film) is placed on the layout board. An individual separates the colors by transferring the artwork by hand to one or more carrier sheets. In this separation/transference process, each carrier sheet represents a separate color to be used in the final screened product. Thus, if there are six (6) colors being screened, there will be six (6) carrier sheets (Art Separations) completed and six (6) screens ultimately employed.

Second, the screens are made. A vacuum exposure unit has basically three elements, that being a light/vacuum source, a cover, and a table disposed therebetween. Each carrier sheet is aligned with a blank screen, the cover is closed, and the screen/carrier sheet combination is subjected to vacuum and light. The result is a printing screen. The screen has interstices in the places where ink of a particular color is to be deposited onto the substrate to be printed upon (each color involves a different stenciled screen).

Third, each printing screen is secured to a printing head. As mentioned above, ink is then placed into the printing heads. The substrates to be printed upon, e.g., textiles, one at a time, are loaded onto the traveling pallets and the pallets travel to each of the printing stations. The ink is applied to each textile through the screen at each station. Each textile is cured and the ink permitted to set.

The screens employed are reusable. As such, once a job is completed, the screens, each held in a frame, are removed from the printing machine and brought to a cleaning room or cleaning area. In the cleaning area, the frames are typically leaned up against a wall or other stationary vertical surface and hosed down with water by an individual. Cleaning solvents, well known in the industry, are also applied to the screens during the cleaning process, e.g., before hosing, to facilitate the screens' cleaning. The water and chemicals are caught by a drainage system below/adjacent the screens and removed from the facility.

To thoroughly clean each screen, each screen's front surface and back surface must be sprayed several times. This typically means that the individual cleaning the screens will hose, or spray, their front surfaces, then physically flip or rotate the screens, and spray, or hose their back surfaces. This will be repeated several times to ensure the screens are thoroughly cleaned. The screens will then be dried and stored for use at a later time.

As can be imagined, the cleaning process can be both time consuming, cumbersome and physically strenuous. In particular, one may have to move/maneuver several screens simultaneously or sequentially, and the individual screens can be quite large and heavy. If the screens are being cleaning in a wash basin, this may require one to lift and/or lower each screen each time it is cleaned or turned. As a result, there is a significant need to facilitate the cleaning process and make it neater, faster, safer and less labor intensive.

In the same vein, similar issues arise when one is coating the screen with chemicals prior to its being exposed and when one is processing the screen after it has been exposed.

As a result, there is a significant need for a mechanism to facilitate common activities associated with preparing screens for use and cleaning such screens after such use in the screen printing process.

### SUMMARY OF THE INVENTION

To facilitate the cleaning, coating, developing and processing of screens used in the screen printing process, a unique stand is employed for supporting the screen during these activities. With respect to cleaning, the stand permits one to clean the front surface of the screen and then the back surface of the screen without touching, lifting or physically moving the screen. Similarly, one can coat or develop the screen while the screen is framed and in the stand of the present invention. From a single location (e.g., standing at one position), one can: process one face of the screen; effectuate rotation of the screen; process the other face of the screen; and, continue repeating this process, all while having the screen securely supported.

According to a first aspect of the present invention, a stand is disclosed for holding a frame with a screen therein, the screen having front and rear surfaces. The stand includes a mechanism/devise therein and associated therewith for rotating the frame to selectively expose either the front surface of the screen or the rear surface of the screen. While rotation can be effectuated manually, the stand uses mechanics, actuated and controlled by fluid (liquid or air) or electronics, to effectuate rotation. The screen is held and supported in the stand in a substantially vertical position. The stand includes a moving member disposed between and interconnecting the supporting/holding members and a controller for moving the supporting/holding members between at least a first position and a second position. In addition, an actuator is employed for selectively activating the controller to move the moving member and the supporting/holding members to either the first position or the second position.

The stand can be fixed and rested upon a surface, such as a floor or table top, or it can be secured to a surface, such as a wall or lip of a wash basin. And, it is moveable from one location to another location. The stand has a bottom portion and a top portion and at least one brace disposed therebetween supporting the top portion in fixed relation to the bottom portion. the embodiment illustrated shows two such braces, though one brace can be easily employed. The top portion has an upper support member and the bottom portion has a lower support member, the upper support member being parallel to the lower support member when holding a frame therebetween.

The upper support member is pivotally connected to the brace(s) and the lower support member is rigidly connected to the brace(s). In addition, the upper support member is biased towards the lower support member such that when an upwardly directed force is applied to the upper support member, it may be rotated away from the lower support member and a frame may be inserted and put into the stand or removed from the stand. When the applied force is removed from the upper support member, the biasing force of the upper support member securely clamps a frame between the upper and lower support members. The upper and lower support members are parallel to one another. The support members are perpendicular or acute with the brace(s).

If two braces are employed instead of one brace, they are spaced apart and substantially parallel to one another. They are further connected to spaced apart upper support members with an upper cross member disposed therebetween and spaced apart lower support members with a lower cross member disposed therebetween.

The internal holding assembly of the stand includes opposed, substantially parallel channel members rotatably connected to the upper support member or upper cross member and the lower support member or lower cross member. The channel members confront one another and each channel member is contoured to permit the frame to sit therein. Shafts, rotatable at least 180 degrees, interconnect each channel member to its adjacent of the support member. The shafts are collinear and at least one of the shafts is rotated by the controller.

The controller is a pneumatic device capable of rotating an associated shaft. In the present invention, the shaft, once activated and energized (with air or liquid) rotates approximately 180 degrees either clockwise or counterclockwise. At least one of the shafts is the driving shaft and one of the shafts is the following shaft.

The actuator for the system is switch assembly, foot peddle assembly, timer assembly or similar device. The actuator, in combination with a diverter, control the controller. Briefly, in the illustrated system, each depression of the foot peddle causes a pulse of air to travel from the foot peddle to a diverter, causing the diverter to alternate air flow between one of the two feed lines to a controller that rotates the shafts supporting the frames. The foot peddle acts as the actuator and the diverter acts as the switch or baffle for directing air to the controller and causing the resulting rotation.

Other advantages and aspects of the present invention will become apparent upon reading the following description of the drawings and detailed description of the invention.

### BRIEF DESCRIPTION OF THE DRAWINGS

In the accompanying drawings forming part of the specification, and in which like numerals are employed to designate like parts throughout the same,

FIG. 1 is a perspective front view of the screen stand of the present invention;

FIG. 2 is a front elevation view of the screen stand of FIG. 1;

FIG. 3 is a side elevation view of the screen stand of FIG. 1;

FIG. 4 is a front perspective view of the controller on top of the stand of FIG. 1; and,

FIG. 5 is a perspective view of the foot pedal and diverter for the stand of FIG. 1.

### DETAILED DESCRIPTION

While this invention is susceptible of embodiments in many different forms, there is shown in the drawings and will herein be described in detail preferred embodiments of the invention with the understanding the present disclosure is to be considered as an exemplification of the principles of the invention and is not intended to limit the broad aspect of the invention to the embodiments illustrated.

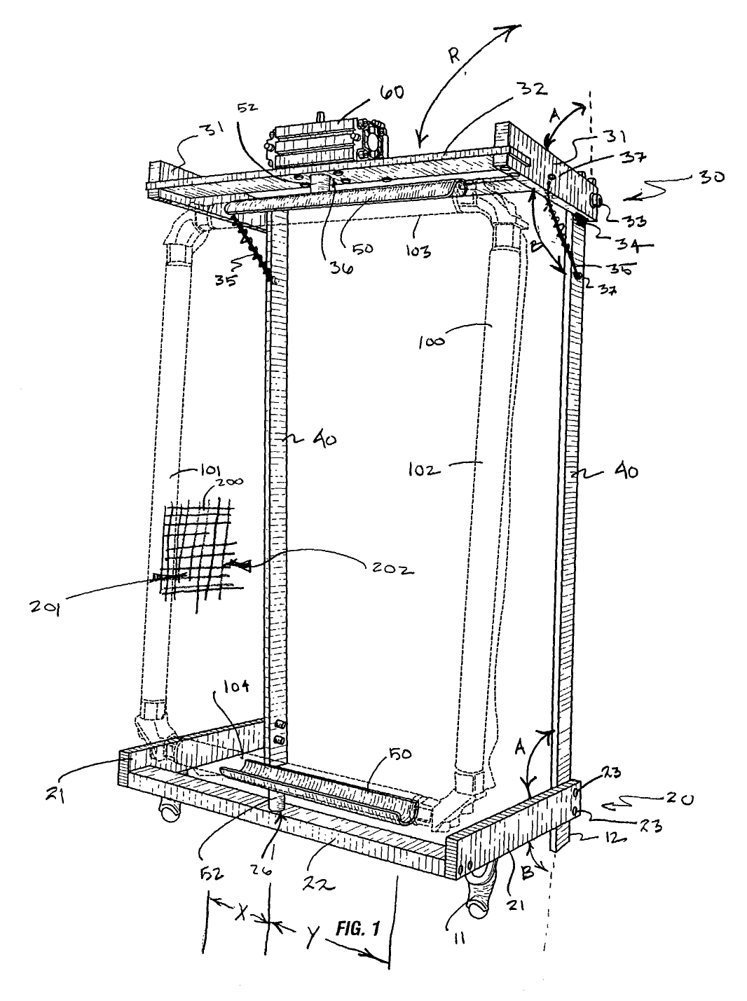

Turning to FIG. 1, a frame 100 is shown in phantom lines. This is a frame, commonly used in the screen printing industry for printing upon substrates, such as paper or board, and textiles, such as shirts, hats and pants. The frame 100 is generally rectangular and has opposed sides 101,102 and opposed ends 103,104 with a screen 200 securely and tightly held within the frame. The screen 200 has a front face 201 and a back face 202.

The stand of the present invention is generally designated with the reference number 10. The stand 10 is constructed to both hold the frame generally vertically and to rotate the frame 100 to selectively expose either the front face 201 of the screen 200 or the back face 202 of the screen. This rotation can be accomplished either manually (by physically rotating the screen while in the stand) or mechanically (by actuating rotation by switch or control means). The stand 10 includes primary components for supporting the frame, holding the frame in a non-horizontal position, moving the frame, e.g., rotating or flipping it, controlling the movement of the frame and actuating the movement of the frame. In addition, the stand of the present invention can be fixed/secured to a surface and/or rested upon a surface, such as a wash basin, and easily moved from one location to another location.

As to the general configuration, the stand 10 has a bottom portion 20 comprising a pair of generally parallel lower support members 21 and one or more lower cross members 22 interconnecting the lower support members. The frame also has a top portion 30 comprising a pair of generally parallel upper support member 31 and one or more upper cross members 32 interconnecting the upper support members. The top portion 30 is connected and held above the bottom portion 20 by a pair of generally vertical and parallel braces 40. As noted, the lower support members 21 are generally parallel to each another and the upper support members 31 are generally parallel to each other. In addition, the lower support members 21 are preferably parallel to the upper support members 31. The cross members 22,32 are rigidly connected to a support members 21,31 at each side thereof and generally parallel to one another.

The braces 40 are attached to the support members 21,31, with each brace being connected to a single upper support member and to a single lower support member. Feet for the stand can be either separately constructed 11 or formed by extending the braces downwardly 12. While not shown, the feet 11,12 can include means for rolling the stand, such as wheel or casters, and/or means for locking the stand in position (e.g., wheel locks) and/or means for securing the stand to a particular location (e.g., clamps).

The lower portion 20 (the support members 21 and the cross member 22) are rigidly connected with fasteners 23 to the braces 40 while the upper portion 30 (the support members 31 and the cross member 32) are pivotally connected with a pivot pins 33 to the braces 40. As a result, the lower portion 20 is fixed and does not move relative to the braces 40 while the upper portion 30 rotates about the braces 40 and relative to the lower portion 20. The rotation of the upper portion 31 about the braces 40 is shown with motion arrow R in FIGS. 1 and 3. If desired, a block or stop 34 may be welded upon the outer surface of the braces 40 or the outer surface of the upper support members 31 to stop or prevent further movement of the top portion 30 relative to the braces 40.

The support members 21,31 can be perpendicular, but they need not be. They can be pitched towards the braces. In particular, the support members are attached to the braces 40 such that they are pitched/angled downwardly when moving from the front to the back. As a result, angle A, shown in FIG. 1, is acute, that is less than 90 degrees, and the complimentary angle B is obtuse, that is greater than 90 degrees. In the preferred embodiment, angle A is about 83 degrees and angle B is about 97 degrees.

One or more biasing springs 35 attached to the posts 37 on the braces 40 and upper support members 31 bias the top portion 30 towards the bottom portion 20. Consequently, the top portion 30 acts like a lid or hinge. The top portion may be lifted (rotated away from the bottom portion) to remove or insert and seat a frame 100 into the stand or released to sandwich, or clamp, the frame against the bottom portion. The springs, or pneumatic cylinders if desired, urge the upper portion 30 into the top end 103 of the frame 100 and the lower end 104 of the frame into the bottom portion 20. In this manner, the frame 100 can be securely held and clamped in the stand 10 between the upper portion 30 and the bottom portion 20 of the stand 10. In addition, this construction allows frames to be easily inserted into and removed from the stand.

The stand 10 further includes a holding assembly that incorporates channel members 50 rotatably connected to the upper cross member 32 and the lower cross member 22. Specifically, channels members 50 are contoured to match the outer surfaces of the frame 100 so as to permit the upper and lower ends of the frame 103,104 to sit within the channels of the channel members. It is recognized that these channel members can be customized, shaped, contoured or even keyed so as to fit, hold and secure different shaped or sized frames. It is important to note that the channels confront one another meaning that their open troughs face one another to support the frame disposed therein. In addition, the upper shaft 50 is collinear with the lower shaft 50. In this manner, an imaginary axis of rotation passes through both shafts 50.

Both channel members 50 are interconnected to a respective cross member by a shaft 52. Each shaft 52 rotates relative to the cross member it is linked to Specifically, passageways 26,36 are provided in the cross members 22,32 to permit the shafts 52 to pass therethrough. In the embodiment shown, and as will be explained in more detail below, the upper shaft 52 is the driver, or driving shaft, driven by a controller 60, and the lower shaft 52 is the follower, or following shaft. Thus, the upper shaft 52 rotates the upper channel member 50 and hence the frame 100 it is mated with. The rotating frame 100 rotates the lower channel member 50 and lower shaft 52. If there is no frame in the stand 10 and the upper shaft 52 is rotated, the lower shaft 52 and channel member 50 will not move.

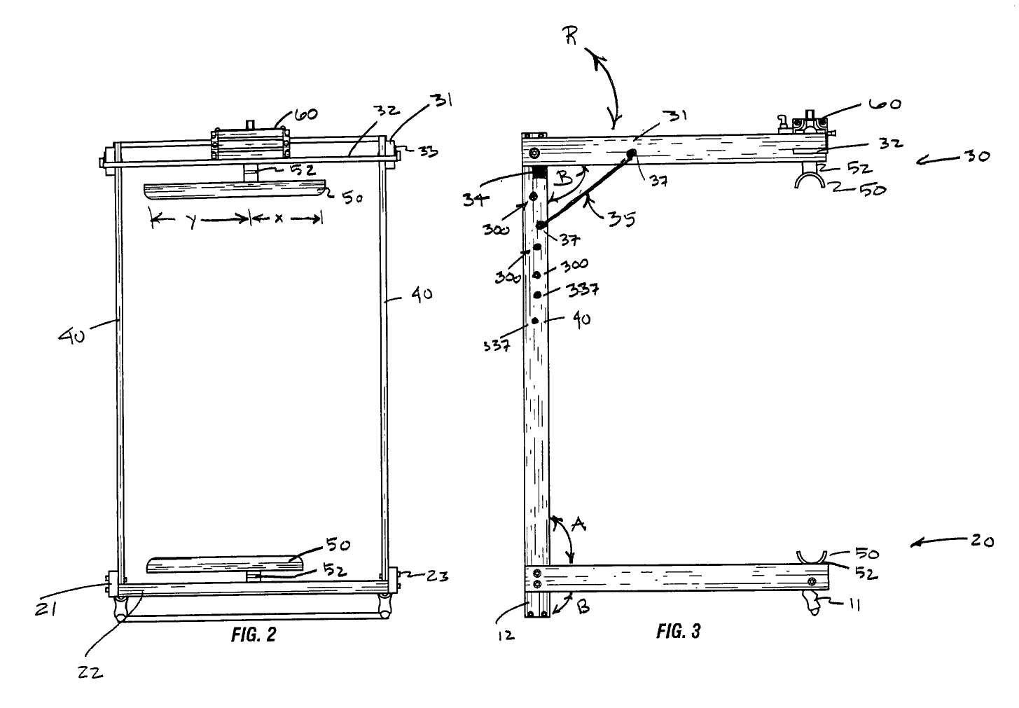

It should be further noted that the shafts 52 are connected to the channel member 50 at locations other than the center of the channel. Specifically, as shown in FIGS. 1 and 2, the distance X (center point to one side of channel) is less than the distance Y (center point to other side of channel). This construction facilitates rotation and permits substantial downsizing of the of the stand, something quite important when a lot of stands are used and/or cleaning space is limited. In particular, by connecting and rotating the channels at a location offset from the center of the channel and frame, the depth of the frame (roughly the length of the support members 21) can be reduced and the width of the frame (roughly the distance between the two braces 40 and the length of the cross members 22,32) can be reduced. Each shaft rotates the channel it supports relative to the cross-member supporting it, and hence, relative to the stand. During operation, the shafts rotate about 180 degrees clockwise and counterclockwise.

The upper shaft 52 is driven and rotated by a controller 60. This controller 60 is attached to the upper surface of the upper cross member 32 and performs two functions, that being receiving an actuating and driving force (here, air or ac or dc power) and rotating the shaft 52 clockwise or counterclockwise. The process of rotation when a frame 100 is secured in the stand 10 is as follows:

1) the upper shaft 52 is at rest; the controller 60 is idle; and the front face 201 of the screen 200 within the frame 100 is facing outwardly from the stand 10 (towards the reader). At this point, the front face 201 of the screen 200 may be cleaned, coated or serviced by an individual.

2) a first actuating and driving force/signal is sent to and received by the controller 60.

3) the upper shaft 52 is rotated clockwise approximately 180 degrees by the controller 60; the front face 201 of the screen 200 rotates towards the back of the stand while the back face 202 of the screen 200 rotates towards the front of the stand (towards the reader)).

4) the upper shaft 52 comes to a stop; the controller 60 becomes idle and stops rotating; the back face 202 of the screen 200 within the frame 100 is facing outwardly from the stand 10 (towards the reader).

5) the upper shaft 52 is at rest; the controller 60 is idle; and the back face 202 of the screen 200 within the frame 100 is facing outwardly from the stand 10 (towards the reader). At this point, the back face 202 of the screen 200 may be cleaned, coated or serviced by an individual.

6) a second actuating and driving force/signal is sent to and received by the controller 60.

7) the upper shaft 52 is rotated counterclockwise approximately 180 degrees by the controller 60; and the back face 202 of the screen 200 rotates towards the back of the stand while the front face 201 of the screen 200 rotates towards the front of the stand (towards the reader)).

8) the upper shaft 52 comes to a stop; the controller 60 becomes idle and stops rotating; and the front face 201 of the screen 200 within the frame 100 is facing outwardly from the stand 10 (towards the reader).

9) the upper shaft 52 is at rest; the controller 60 is idle; and the front face 201 of the screen 200 within the frame 100 is facing outwardly from the stand 10 (towards the reader). At this point, the front face 201 of the screen 200 may again be cleaned, coated or serviced by an individual.

The above procedure can be repeated over and over again and an individual can clean the front face and back face many times, which is quite common in the industry.

It should be noted that because the stand's depth (roughly the length of the support members 21) is less than half the width of the frame 100, the screen is rotated back and forth, or clockwise and counterclockwise, 180 degrees each rotation, as opposed to continuously, clockwise 180 degrees and again clockwise 180 degrees. In short, the rotation is 180 degrees back and forth as opposed to 360 degrees. It is recognized, of course, that if the stand is made deeper, rotation can be a full 360 degrees within the stand.

Bumpers (not shown) can be secured to the braces 40, support members 21 or cross members 22,32 to dampen the rotation of the frame 100 within the stand. Such bumpers can be used to stop and/or soften the end point of the rotation of the frame each time it rotates.

The controller 60 thus receives a first signal/force and rotates clockwise a certain amount (about 180 degrees) and stops; when the controller receives the second force/signal it rotates counter clockwise a certain amount (about 180 degrees) and stops. With each actuating or driving signal/force received, the controller will alternate rotations from clockwise to counterclockwise or from counterclockwise to clockwise.

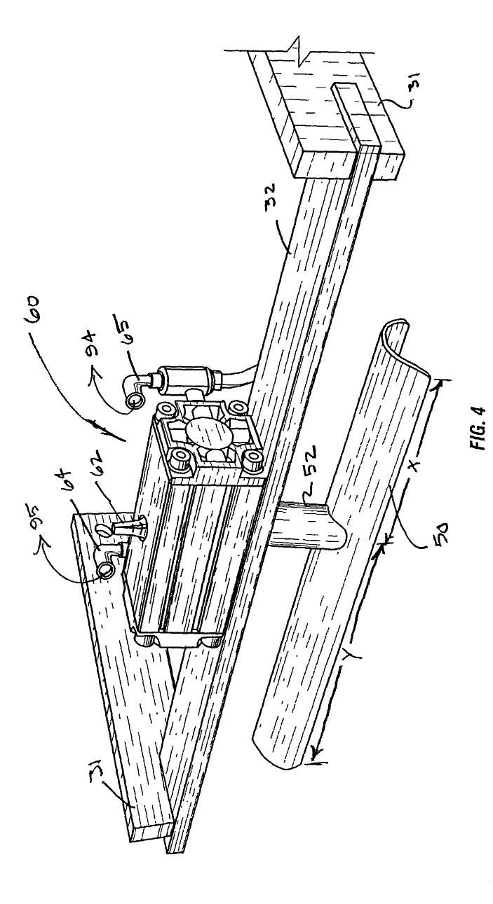

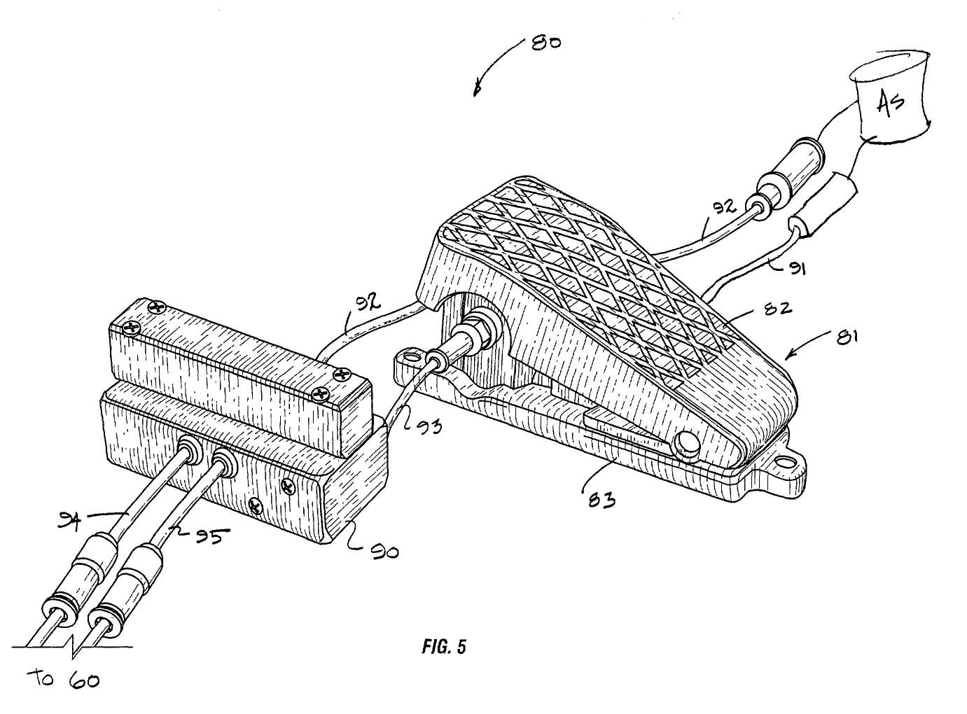

This rotation is actuated and performed by three primary components, that being the controller 60 (FIG. 4) and a foot peddle assembly 80 comprised of a foot peddle 81 and diverter 90 (FIG. 5). The foot peddle assembly 80 is connected to the controller 60 and an air supply (shown schematically in FIG. 5 and designated AS), such as a compressor or air tank. In particular, the foot peddle 81 acts as a toggle switch for the system and controlled motion of the screen and frame. The peddle 81 includes a hinged contact surface 81 and a base 82. When pressure is applied to the contact surface 81, it pivots relative and towards the base 82 and sends a pulse of air to the diverter 90 which, in turn, toggles the air flow to the controller 60. A first air supply line 91 connects the air supply AS directly to the peddle 81 and is for the signal, or pulse of air. This supplies the air necessary to switch, activate and send the signal, namely a pulse of air, from the peddle to the diverter 90. A second air supply line 92 connects the air supply AS to the diverter 90. A separate signal line 93 for carrying the pulse of air from the peddle connects the peddle 81 to the diverter 90; the diverter also has two exiting air lines that act as feed lines 94,95 to the controller 60 (FIG. 4). In general terms, when the foot peddle 81 is depressed and released, a pulse of air is sent to the diverter, which acts as the toggle or switch, sending air in one 94 of the two feed lines 94,95 to the controller 60 to cause rotation in one direction (clockwise or counterclockwise) of the upper shaft 52 and the upper channel 50. When the foot peddle 81 is depressed and released a second time, a pulse of air is sent to the diverter, which in response to the second signal sends air in the other one 95 of the feed lines 94,95 to the controller 60 to cause the rotation in the oppose direction (counterclockwise or clockwise) of the upper shaft 52 and upper channel 50. In summary, each depression of the foot peddle 81 causes a pulse of air to travel from the foot peddle 81 to the diverter 90, causing the diverter to alternate air flow between one of the two feed lines 94,95 to the controller 60. The foot peddle acts as the actuator and the diverter acts as the switch or baffle for directing air to the controller and causing the resulting rotation.

The controller 60 uses an internal rotary actuator and pushes against internal racks which are, in turn, in communication with an internal gear that drives the upper shaft and rotates the screen. Such controllers are commercially available and well known. The controller thus receives air, releases air, and causes rotation of the shaft 52 connected therewith. Typical controllers 60 include means, such as knobs 62 for controlling the flow of air into and out of the controller, the amount of rotation (90°,180°, 270°, etc.), the rotational speed of such rotation, and the amount, if any, of dampening of rotation at the end of a particular rotation. It further includes intakes and flow controls 64,65 for receiving the feed lines from the diverter 90.

It is further understood, that controlled motion, as described above, can be accomplished any one of a number of ways. Here it is described as using pressurized air. The controlled motion may be effectuated by other well known manners, such as with pneumatics (oil, air, etc.), electronics (switches, batteries, current, etc.) and other mechanical mechanisms (motors, gears, belts, etc.). In addition, the actuating or toggling mechanism, shown as a foot peddle herein, may be another mechanism, such as a timer or an electronic hand switch. One skilled in the art can use a myriad of different components to accomplish the equivalent or similar motions and effects.

Screen frames typical range from abut 6 inches to 30 inches wide and 30 inches to about 40 inches heigh. Typical frames however are 23-27 inches wide and about 33 inches heigh. As such, the stand must be capable of supporting such widths. To accommodate screens of differing heights, a number of different adjustable mechanisms may be employed. Specifically, apertures 300 or posts 337 may be put into or onto the braces 40 to permit the lowering (or raising) of the top portion 30 relative to the braces. In such instances, the pivot pins 33 are removed from one aperture and put in another aperture 300 and the biasing spring 35 is removed from one post 37 to another post 337. In the alternative, one or both of the shafts 52 supporting the channels 50 may be telescoping, allowing its height or length to be adjusted. While not shown, a telescoping shaft—permitting the shaft itself to be unlocked, lengthened or shortened and re-locked, may be easily understood by one versed in the technology. Similarly, the braces 40 may be telescoping and releasably locked so that one may easily adjust the relative distance between the lower portion 20 of the assembly 10 and the upper portion 30 and accommodate framed screens 100,200 of different heights.

While the braces 40 of the embodiment 10 illustrated are shown as generally two parallel members, they may instead be a single member. A single brace 40 can be used to connect the upper and lower portions, support the screened frame and cause controlled rotation. Such a single braced stand may be especially desired where weight or space limitations are important.

While the specific embodiments have been illustrated and described, numerous modifications come to mind without significantly departing from the spirit of the invention and the scope of protection is only limited by the scope of the accompanying claim.

What is claimed is:

1. A stand for holding a frame with a substrate therein, the substrate having front and rear surfaces, comprising:
means for rotating the frame to selectively expose either the front surface of the substrate or the rear surface of the substrate.

2. The stand of claim 1 wherein the rotating means includes manually rotating the frame.

3. The stand of claim 1 wherein the rotating means includes means for mechanically rotating the frame.

4. The stand of claim 1, further including means for holding the frame in a substantially vertical position.

5. A stand for supporting a substantially rectangular frame with a substrate therein, the substrate having front and rear surfaces, comprising:
means for supporting opposed ends of the frame and holding the frame in a non-horizontal position; and,
means for selectively rotating the frame so as to have either the front surface of the substrate or the rear surface of the substrate face frontwardly of the stand.

6. A stand for supporting a substantially rectangular frame with a substrate therein, the substrate having front and rear surfaces, comprising:
a support member capable of supporting the weight of the frame and substrate;
at least one holding assembly for holding the frame in a non-horizontal position;
a moving member interconnecting the support member and holding assembly for moving the holding element and the frame relative to the support member;
a controller for moving the moving member and the holding element between at least a first position and a second position;
an actuator for selectively activating and causing the controller to move the moving member and the holding element to either the first position or the second position.

7. The stand of claim 6 wherein the support member is fixed and can rest upon a surface or be secured to a surface.

8. The stand of claim 6 wherein the support member is moveable from one location to another location.

9. The stand of claim 6 wherein the support member has a bottom portion and a top portion and at least one brace disposed therebetween supporting the top portion in fixed relation to the bottom portion.

10. The stand of claim 9 wherein the top portion has an upper support member and the bottom portion has a lower support member.

11. The stand of claim 10 wherein the upper support member is parallel to the lower support member.

12. The stand of claim 11 wherein the upper support member is pivotally connected to the brace and the lower support member is rigidly connected to the brace.

13. The stand of claim 12 wherein the upper support member is biased towards the lower support member such that when force is applied to the upper support member, it may be rotated away from the lower support member and a frame may be put into the stand or removed from the stand, and when the force is removed from the upper support member, the biasing force of the upper support member clamps a frame between the upper and lower support members.

14. The stand of claim 13 wherein the angle the upper and lower support members make with the brace is acute.

15. The stand of claim 6 wherein the support member has a bottom portion and a top portion and at least two braces disposed therebetween supporting the top portion in fixed relation to the bottom portion.

16. The stand of claim 15 wherein the top portion has at least two substantially parallel, spaced apart upper support members and an upper cross member disposed therebetween and connected to each of the upper support members and the bottom portion has at least two substantially parallel, spaced apart lower support members and a lower cross member disposed therebetween and connected to each of the lower support members.

17. The stand of claim 16 wherein the upper support members are parallel to the lower support members.

18. The stand of claim 17 wherein the upper support members are pivotally connected to the braces and the lower support members are rigidly connected to the braces.

19. The stand of claim 18 wherein the upper support members are biased towards the lower support members such that when force is applied to the upper support members, they may be rotated away from the lower support members and a frame may be put into the stand or removed from the stand, and when the force is removed from the upper support members, the biasing force of the upper support members clamps a frame between the upper and lower support members.

20. The stand of claim 19 wherein the angle the upper and lower support members make with the braces is acute.

21. The stand of claim 6 wherein the holding assembly includes at least one channel member rotatably connected to one of either the upper support member and the lower support member and contoured to permit the frame to sit therein.

22. The stand of claim 6 wherein the moving member is at least one shaft rotatable at least 180 degrees interconnecting the channel member to one of the support members.

23. The stand of claim 22 wherein the shaft is rotated by the controller.

24. The stand of claim 6 wherein the holding assembly includes at least one upper channel member rotatably connected to the upper support member and at least one channel member rotatably connected to the lower support member, the channel members confronting one another, being parallel to one another, and being contoured to permit the frame to sit therein.

25. The stand of claim 6 wherein the moving member includes at least one upper shaft rotatable at least 180 degrees interconnecting the upper channel member to the upper support member and at least one lower shaft rotatable at least 180 degrees interconnecting the lower channel member to the lower support member, the upper shaft being collinear with the lower shaft.

26. The stand of claim 25 wherein at least one of the shafts is rotated by the controller.

27. The stand of claim 6 wherein the holding assembly includes at least one channel member rotatably connected to one of either the upper cross member and the lower cross member and contoured to permit the frame to sit therein.

28. The stand of claim 6 wherein the moving member includes at least one shaft rotatable at least 180 degrees interconnecting the channel member to one of the cross members.

29. The stand of claim 28 wherein the shaft is rotated by the controller.

30. The stand of claim 6 wherein the holding assembly includes at least one upper channel member rotatably connected to the upper cross member and at least one channel member rotatably connected to the lower cross member, the channel members confronting one another, being parallel to one another, and being contoured to permit the frame to sit therein.

31. The stand of claim 6 wherein the moving member includes at least one upper shaft rotatable at least 180 degrees interconnecting the upper channel member to the upper cross member and at least one lower shaft rotatable at least 180 degrees interconnecting the lower channel member to the lower cross member, the upper shaft being collinear with the lower shaft.

32. The stand of claim 31 wherein at least one of the shafts is rotated by the controller.

33. The stand of claim 6 wherein the controller is a pneumatic diverter that when activated rotates the associated shaft approximately 180 degrees either clockwise or counterclockwise.

34. The stand of claim 6 wherein the controller is a pneumatic diverter driving at least one of the shafts and toggling, when activated, between a clockwise rotation of approximately 180 degrees and a counterclockwise rotation of approximately 180 degrees.

35. The stand of claim 34 wherein the pneumatics is one of air, water and oil.

36. The stand of claim 6 wherein the actuator is switch for activating and directing the controller to toggle and either rotate the associated shaft clockwise or counterclockwise.

37. The stand of claim 6 wherein the actuator is one of a hand switch, foot peddle or timer.
